(19) United States
(12) Patent Application Publication
(10) Pub. No.: US 2002/0018466 A1
(43) Pub. Date: Feb. 14, 2002

(54) Communication parts comprising operating system and waiting system therein

(75) Inventor: Takahiro Arai, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/918,545

(22) Filed: Aug. 1, 2001

(30) Foreign Application Priority Data
Aug. 1, 2000 (JP) 2000-233747

(51) Int. Cl. H04L 12/50

(52) U.S. Cl. 370/380; 370/386

(57) ABSTRACT

A communication parts of the present invention comprises first and second electronic circuit packages which are employed as an operating system or a waiting system, a switch which changes a system following instruction, a first signal level detect station which detects a signal level of output signals from a transmitter in the first electronic circuit package, a second signal level detect station which detects a signal level of output signals from a transmitter in the second electronic circuit package and a switch control station which changes and controls the switch on the basis of detection result from the first and second signal level detect stations. Consequently, communication parts of the present invention realizes changing a system with a simple structure.

### BACKGROUND OF THE INVENTION

This invention relates to a communication parts such as a router, comprising a plurality of systems at the inside. More specifically, this invention relates to a communication parts wherein one of the systems is employed as an operating system and the other is employed as a waiting system.

Description of the Related Art

A general structure of a system including a communication parts (device) are shown in FIG. 1 and FIG. 2. The communication parts comprise a plurality of systems wherein one of the systems is employed as an operating system and the other is employed as a waiting system. FIG. 1 and FIG. 2 are schematic block diagrams showing an example of a system including a communication parts.

In a system shown in FIG. 1, a communication parts 400, passing Y-branch connectors 430 and 440, is connected to an opposite communication parts 450. Both the communication parts 400 and the opposite communication parts 450 are communication parts such as a router and a switching equipment, provided with interface function which enables the communication parts to transmit and receive information with other parts by electric signals or optical signals. The communication parts 400 comprises electronic circuit packages 410 and 420 that transmit and receive information with the opposite communication parts 450. The electronic circuit packages 410 and 420 are connected to external parts, whereof examples are an information terminal such as a personal computer, a router and a switching equipment. The electronic circuit packages 410 and 420 can be, for example, interface boards which transmit and receive information between external parts and the opposite communication parts 450.

The electronic circuit package 410 comprises a transmitter 411 which receives signals from an external parts and transmits them to the opposite communication parts 450, and a receiver 412 which receives signals from the opposite communication parts 450 and transmits them to the external parts. In the same manner, the electronic circuit package 420 comprises a transmitter 421 and a receiver 422. One of the electronic circuit packages 410 and 420 is employed as an operation system, and the other as a waiting system. Signals received at the transmitters 411 and 421, passing the Y-branch connector 430, are transmitted to the opposite communication parts 450. In the same way, signals of the opposite communication parts 450, being segmented at the Y-branch connector 440, are transmitted to the receivers 412 and 422.

Employing the electronic circuit package 410 as an operating system and the electronic circuit package 420 as a waiting system, signal output from the transmitter 421 is deactivated in order to avoid mutual interference of input signals at the Y-branch connector 430. Deactivation of signal output is executed by stopping power supply to the transmitter 421 by using such as a power feeding control circuit. By transmitting signals only from the transmitter 411, passing the Y-branch connector 430, to the opposite communication parts 450, the path between the electronic circuit package 410 and the opposite communication parts 450 is established. Further, signals from the opposite communication parts 450, being segmented at the Y-branch connector 440, are transmitted to the receivers 412 and 422. Still further, in the same way as the above-mentioned, in case of employing the electronic circuit package 410 as a waiting system and the electronic circuit package 420 as an operating system, signal output from the transmitter 411 is deactivated.

In a system shown in FIG. 2, a communication parts 500 and an opposite communication parts 450 are connected. The communication parts 500 can be a router, which is same as the communication parts 400 shown in FIG. 1. In addition, an electronic circuit package 410, an electronic circuit package 420 and the opposite communication parts 450 indicate the same components shown in FIG. 1.

The electronic circuit packages 410 and 420, passing a switch station 520, are connected to the opposite communication parts 450. The switch station 520 comprises a switch 521 being connected to transmitters 411 and 421, and a switch 522 being connected to receivers 412 and 422.

A control system package 510 outputs system selection signals to the switches 521 and 522. The switch 521, based on a system selection signal, changes a switch to the side of either the transmitter 411 or 421. Signals from either the transmitter 411 or 421, passing the switch 521, are transmitted to the opposite communication parts 450. In the same manner, the switch 522 changes a switch to the side of either the receiver 412 or 422. Signals from the opposite communication parts 450, passing the switch 522, are transmitted to the receiver 412 or 422.

In a communication parts shown in FIG. 1, signals from the electronic circuit package 410 or 420, passing the Y-branch connector 430, are transmitted to the opposite communication parts 450. Signals from the opposite communication parts 450, being segmented at the Y-branch connector 440, are transmitted to the electronic circuit packages 410 and 420. In the above-described process, transmission loss of signals can be generated at the Y-branch connectors 430 and 440, and transmission performance between the communication parts 400 and the opposite communication parts 450 can be deteriorated.

Further, in order to avoid mutual interference of input signals at the Y-branch connector 430, it is necessary to have output signals from either the electronic circuit package 410 or 420 invalid. In this process, power supply to either the electronic circuit package 410 or 420 has to be deactivated, or power supply to either the transmitter 411 or 421 has to be deactivated. Thus, it possibly becomes necessary to provide an additional parts such as a control parts which controls power supply to the electronic circuit packages 410 and 420, and consequently the internal structure of a communication parts will be complicated.

In the communication parts shown in FIG. 2, since the control system package 510 and dedicated lines connecting the control system package 510 and the switches 521 and 522 are required for changing the setting of the switches 521 and 522, the internal structure of a communication parts will be complicated.

The present invention was developed in order to solve the above-mentioned problems and shortcomings.

### SUMMARY OF THE INVENTION

Accordingly, it is an object of the present invention to provide a communication parts which realizes changing of a system with a simple structure.

A communication device (parts) of the present invention is featured in that a switch station is provided, which selects a system to transmit and receive information with other parts by detecting a signal level of output signals from each system. Among a plurality of systems which the communication parts are provided with, one system is employed as an operation system and the other is as a waiting system.

The switch station comprises a switch which changes a system following an instruction, a signal level detect station which detects a signal level of output signals from each system and a switch control station which changes and controls a switch on the basis of the detection result of a signal level. The signal level detect station judges whether a signal level of output signals from each system is threshold value and over, or not, and the switch control station changes and controls a switch for a system which outputs signals whose signal level is threshold value and over. In this process, the waiting system adjusts a signal level of output signals to be below threshold value, and the operating system adjusts the signal level of output signals to be threshold value and over.

### BRIEF DESCRIPTION OF THE DRAWINGS

The objects and features of the present invention will become more apparent from the consideration of the following detailed description taken in conjunction with the accompanying drawings in which:

FIG. 1 is a schematic block diagram showing an example of a structure of a system including a general communication parts;

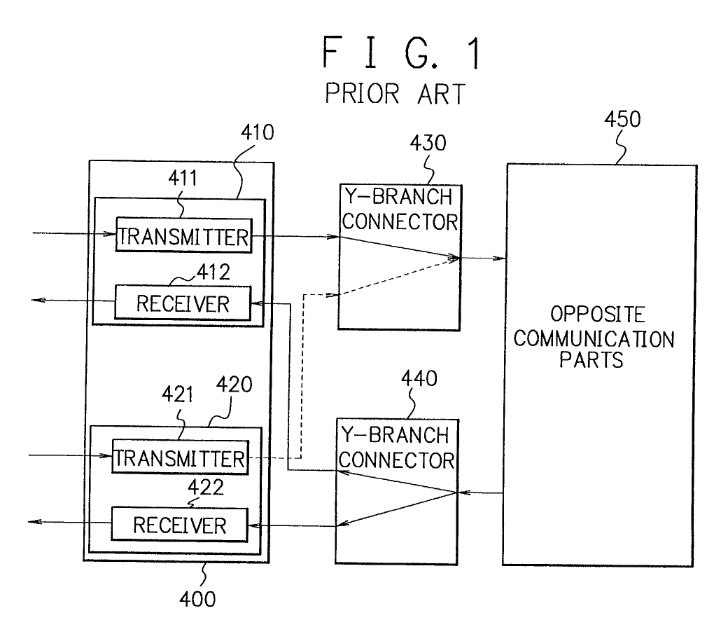

FIG. 2 is a schematic block diagram showing an example of a structure of a system including a general communication parts;

FIG. 3 is a schematic block diagram showing an example of a structure of a system including a communication parts of the present invention;

FIG. 4 is an explanatory drawing in order to explain an operation of a system shown in FIG. 3; and

FIG. 5 is an explanatory drawing in order to explain an operation of a system shown in FIG. 3.

### DESCRIPTION OF THE PREFERRED EMBODIMENTS

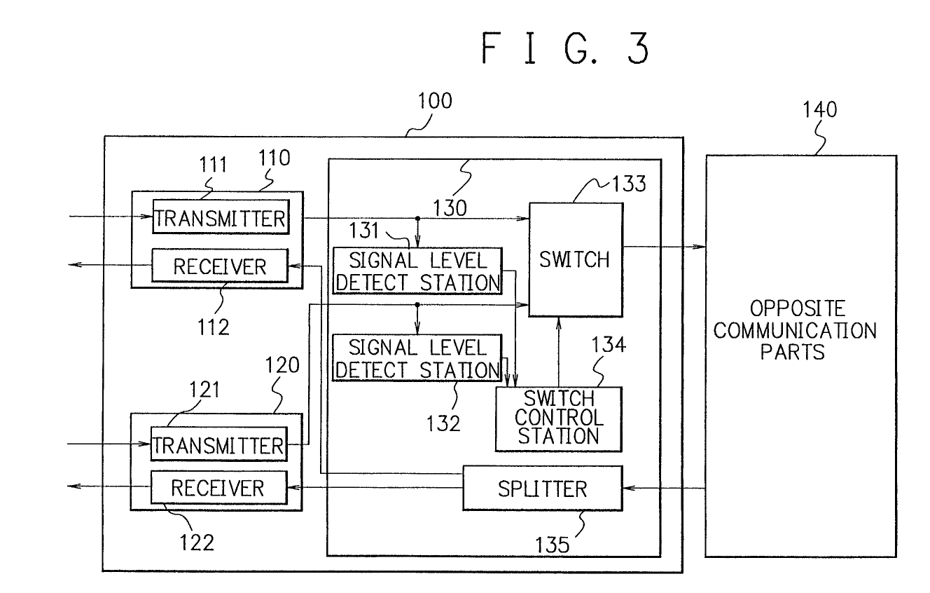

In order to describe the present invention of a communication parts in detail, a description is given of preferred embodiments with reference to the accompanying drawings. FIG. 3 is a schematic block diagram showing an example of a structure of a system including a communication parts of the present invention.

A communication parts 100 transmits and receives information with an opposite communication parts 140 by electric signals or optical signals. The communication parts 100 and the opposite communication parts 140 are communication parts, such as a router or a switching equipment, provided with interface function which enables them to transmit and receive information with other parts by electric signals or optical signals.

The communication parts 100 comprises electronic circuit packages 110 and 120 which transmit and receive information through a system switching station 130 with the opposite communication parts 140. The electronic circuit packages 110 and 120 are connected to external parts such as a personal computer, a router and a switching equipment. One of the electronic circuit packages 110 and 120 is employed as an operation system and the other as a waiting system.

The electronic circuit package 110 comprises a transmitter 111 which receives signals from an external parts and transmits them to the opposite communication parts 140, and a receiver 112 which receives signals from the opposite communication parts 140 and transmits them to the external parts. In the same manner, the electronic circuit package 120 comprises a transmitter 121 and a receiver 122. The electronic circuit packages 110 and 120 can be, for example, interface boards which transmit and receive information with an external parts or the opposite communication parts 140 by electric signals or optical signals.

A signal level detect station 131 detects a signal level of output signals from a transmitter 111 and outputs a detection result to a switch control station 134. In the same manner, a signal level detect station 132 detects a signal level of output signals from a transmitter 121 and outputs a detection result to the switch control station 134. The switch control station 134 outputs switching signals to a switch 133 on the basis of the inputted detection result. The signal level detect stations 131 and 132 are composed of such as a voltage supervisory parts (i.e., a comparator) or a light wave level supervisory parts. The switch control station 134 is composed of a logical part, for example, as an IC or a FPGA which generates control signals for changing a switch.

The switch 133, based on a switching signal, changes an internal switch to the side of either the transmitter 111 or 121. Signals from either the transmitter 111 or 121 are transmitted to the opposite communication parts 140. The switch 133 is provided with an amplifier which executes level adjustment by keeping a signal level of output signals for the opposite communication parts at a set level, and a function of executing retiming of waveform of the output signals.

A splitter 135 segments transmit signals from the opposite communication parts 140 and outputs them to the receivers 112 and 122. When transmit signals are electric signals, the splitter 135 segments the transmit signals by an electric circuit, and when transmit signals are optical signals, the splitter 135 segments the transmit signals by such as a prism. Additionally, in the same way as the switch 133, the splitter 135 is provided with an amplifier which executes level adjustment by keeping a signal level of output signals for the opposite communication parts at a set level, and a function of executing retiming of waveform of the output signals.

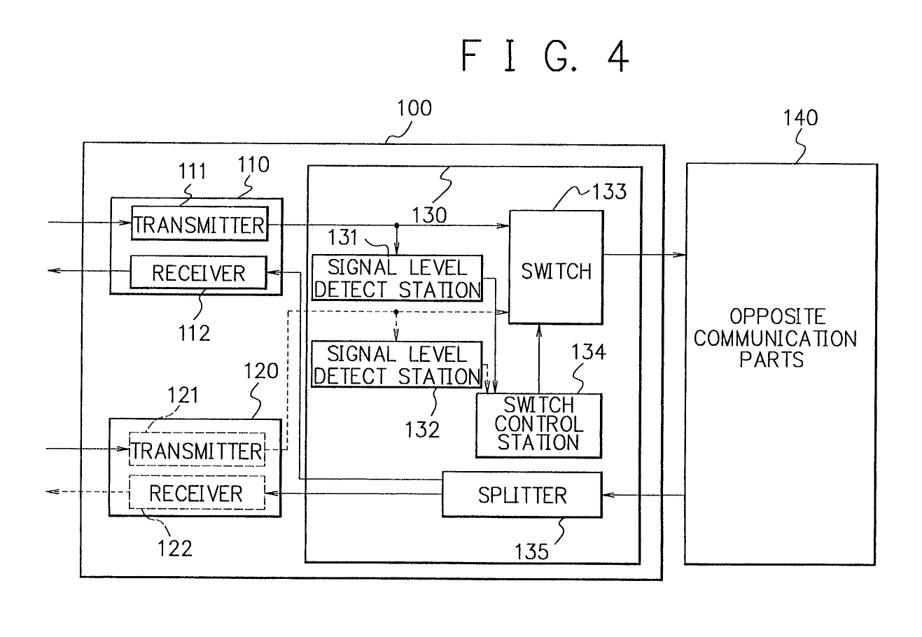

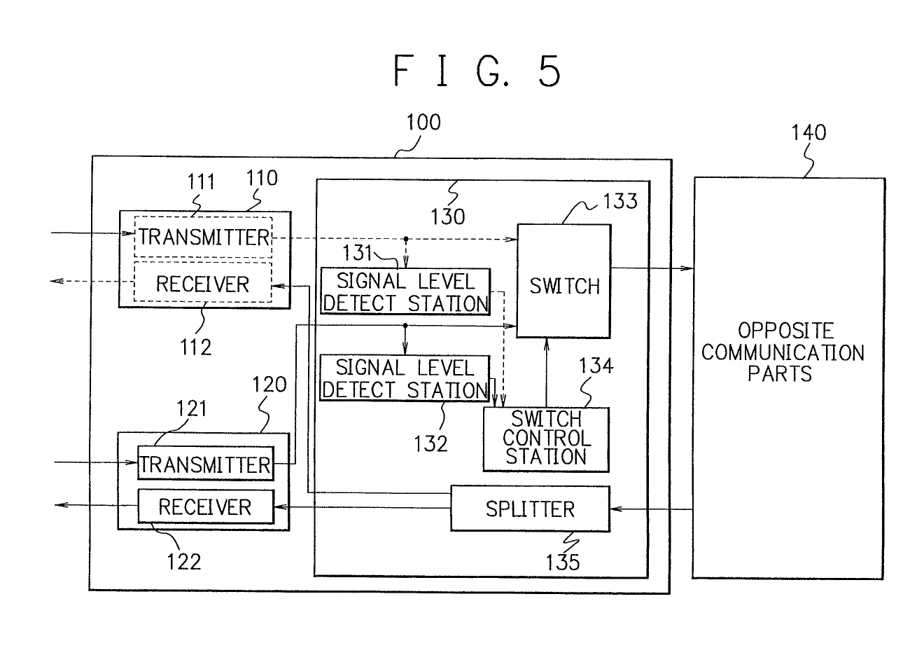

Turning now to FIG. 4 and FIG. 5, there are provided with explanatory drawings in order to explain an operation of a system shown in FIG. 3. First of all, referring to FIG. 4, explanation will be given regarding an operation in case of employing an electronic circuit package 110 as an operating system and an electronic circuit package 120 as a waiting system.

A user may set up the electronic circuit package 110 as an operating system and the electronic circuit package 120 as a waiting system by changing such as a switch provided at the exterior of a communication parts 100, for example. Also, a user may conduct the above-mentioned setting by sending a command to a communication parts 100 from an external parts. Additionally, in case that the communication parts are connected to a network, a user may execute the above-mentioned setting from information terminal of a network by remote operation.

Following the above-mentioned setting, the electronic circuit package 120 as a waiting system stops outputting transmit data (signals) from a transmitter 121 by resetting the transmitter 121 or making it ineffective. In this process, a signal level of transmit signals from the transmitter 121 is adjusted to be an output level lower than threshold value at a system switching station 130. For instance, letting threshold voltage be 1V, a signal level of signals from the transmitter 121, which is in standby state, should be 0V. In case that the transmitter 121 is a luminous parts, the electronic circuit package 120 stops optical generation from the transmitter 121. On the other hand, in the electronic circuit package 110 as an operating system, a transmitter 111 outputs data from a connected external parts as transmit data to a switch 133. In this case, a signal level of transmit signals from the transmitter 111 should be threshold value and over.

In the system switching station 130, a signal level detect station 131 detects a signal level of signals from the transmitter 111 and outputs a detection result to a switch control station 134. In this process, the signal level detect station 131 judges whether a signal level of signals from the transmitter 111 is threshold value and over, or not. In the same way, a signal level detect station 132 outputs a detection result of a signal level of signals from the transmitter 121 to the switch control station 134. In this process, the switch level read station 131 judges that a signal level of signals from the transmitter 111 is threshold level and over, and the signal level detect station 132 judges that a signal level of signals from the transmitter 121 is below threshold value.

The switch control station 134 outputs switching signals to the switch 133 on the basis of a detection result outputted from the signal level detect stations 131 and 132. At the switch control station 134, signals are outputted in order to change the switch 133 to the side of the transmitter 111. The switch 133, based on switching signals, changes a switch to the side of the transmitter 111. In this way, transmit data from the transmitter 111, going through the switch 133, are outputted to an opposite communication parts 140. In this process, the switch 133 executes level adjustment and retiming of transmit signals.

A splitter 135 segments data from the opposite communication parts 140 and outputs the segmented data to the receivers 112 and 122. In the electronic circuit package 110, the receiver 112 receives data from the opposite communication parts 140. The receiver 112 transmits data from the opposite communication parts 140 to a connected external parts. On the other side, the electronic circuit package 120 cancels data from the opposite communication parts 140.

Turning now to FIG. 5, explanation will be given regarding an operation in case of changing an electronic circuit package 110 into a waiting system and an electronic circuit package 120 into an operating system.

A user may set up the electronic circuit package 110 as a waiting system and the electronic circuit package 120 as an operating system. The setting procedure is the same as the previously explained procedure.

The electronic circuit package 110 as a waiting system stops outputting transmit data from a transmitter 111 by resetting the transmitter 111 or making it ineffective. In this process, a signal level of transmit signals from the transmitter 111 is adjusted to be lower than threshold value. Also, the electronic circuit package 110 resets a receiver 112 or makes it ineffective. On the other hand, the electronic circuit package 120 as an operating system, outputs signals from a transmitter 121 to a switch 133 by releasing ineffective condition or reset condition of the transmitter 121. In this process, a signal level of signals from the transmitter 121 should be threshold value and over. In addition, the electronic circuit package 120 releases ineffective condition or reset condition of a receiver 122.

A signal level detect station 131 judges that a signal level of output signals from the transmitter 111 is below threshold value, and a signal level detect station 132 judges that a signal level of output signals from the transmitter 121 is threshold value and over. A switch control station 134 outputs switching signals to the switch 133 to change a switch to the side of the transmitter 121. The switch 133, based on switching signals, changes the switch to the side of the transmitter 121. In this way, transmit data from the transmitter 121 are outputted to an opposite communication parts 140.

Data from the opposite communication parts 140, passing a splitter 135, are transmitted to receivers 112 and 122. The receiver 122 transmits data from the opposite communication parts 140 to an external parts. On the other side, the receiver 112 cancels data from the opposite communication parts 140.

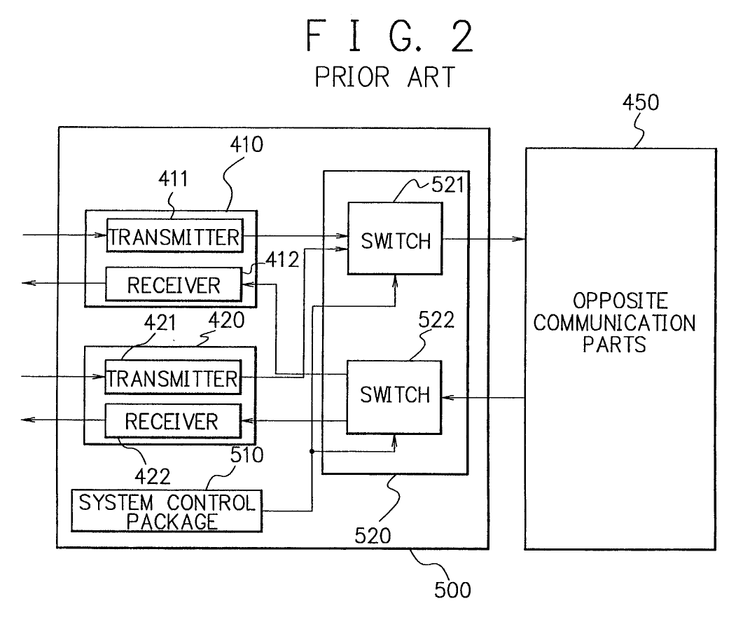

As described above, according to the preferred embodiment of the present invention, since the switch 133 changes a system on the basis of a signal level of output signals from the transmitter 111 or 121, it becomes unnecessary for the communication parts 100 to be provided with a control system package 510 for controlling a switch or dedicated lines for connecting between the control system package 510 and each switch as shown in FIG. 2. In addition, since a system is to be changed without controlling power supply to each system, such parts as a power feeding control parts are not required. Further, since the control system package 510 and a power feeding control parts become unnecessary, lowering the cost can be realized in the present invention by adding a minor change to an existing electronic circuit package.

Still further, signals from each system, passing the switch 133, are transmitted to the opposite communication parts 140, and signals from the opposite communication parts 140 are segmented at the splitter 135 and then transmitted to each system. In this process, since the switch 133 and the splitter 135 execute level adjustment of signals and retiming of signal waveform, transmission loss between the communication parts 100 and the opposite communication parts 140 can be controlled. Thus, the improvement of transmission performance between the communication parts 100 and the opposite communication parts 140 can be expected.

In the above-mentioned embodiment, an example is given in case of employing the switch 133 for changing transmit data from the electronic circuit package 110 or 120, however instead of the switch 133, an IC provided with selector function can be employed. Also, in the example, the splitter 135 is employed for segmenting data from the opposite communication parts 140, but instead of the splitter 135, an IC provided with driver function can be employed. Further, the electronic circuit packages 110 and 120 are included inside the communication parts 100, as an example, but a plurality of electronic circuit packages can be included inside the communication parts 100.

According to a communication parts of the present invention, since a switching station selects a system which transmits and receives information with an external parts on the basis of the signal level of output signals from each system, a control system package to change a switch and dedicated lines to connect between a control system package and each switch become unnecessary. In addition, since a system is to be changed without controlling power supply to each system, such parts as a power feeding control parts are not required. As a result, a system can be realized by using a simple structure.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A communication parts having a plurality of system which transmit and receive information with other parts, selecting some of the systems, comprising:
a switching station selecting a system in the systems for transmitting and receiving information with other parts by detecting a signal level of output signals from each system.

2. A communication parts having a plurality of systems, whereof one system is employed as an operating system and the other is as a waiting system, which transmit and receive information with other parts, selecting some of the systems, comprising:
a switching station selecting a system in the systems for transmitting and receiving information with other parts by detecting a signal level of output signals from each system.

3. A communication parts having a plurality of system which transmit and receive information with other parts, selecting some of the systems, comprising:
a switching station selecting a system in the systems for transmitting and receiving information with other parts by detecting a signal level of output signals from each system, said switching station comprising;
a switch to change a system following an instruction,
a signal level detect station to detect a signal level of output signals from each system, and
a switch control station to change and control a switch on the basis of a detection result of a signal level.

4. A communication parts having a plurality of systems, whereof one system is employed as an operating system and the other is as a waiting system, which transmit and receive information with other parts, selecting some of the systems, comprising:
a switching station selecting a system in the systems for transmitting and receiving information with other parts by detecting a signal level of output signals from each system, said switching station comprising;
a switch to change a system following an instruction,
a signal level detect station to detect a signal level of output signals from each system, and
a switch control station to change and control a switch on the basis of a detection result of a signal level.

5. A communication parts having a plurality of system which transmit and receive information with other parts, selecting some of the systems, comprising:
a switching station selecting a system in the systems for transmitting and receiving information with other parts by detecting a signal level of output signals from each system, said switching station comprising
a switch to change a system following an instruction,
a signal level detect station to detect a signal level of output signals from each system, and
a switch control station to change and control a switch on the basis of a detection result of a signal level,
said signal level detect station judging whether the signal level of output signals from each system is a threshold value and over, or not, said switch control station changes and controls a switch for a system which outputs signals whose signal level is threshold value and over.

6. A communication parts having a plurality of systems, whereof one system is employed as an operating system and the other is as a waiting system, which transmit and receive information with other parts, selecting some of the systems, comprising:
a switching station selecting a system in the systems for transmitting and receiving information with other parts by detecting a signal level of output signals from each system, said switching station comprising;
a switch to change a system following an instruction,
a signal level detect station to detect a signal level of output signals from each system, and
a switch control station to change and control a switch on the basis of a detection result of a signal level,
said signal level detect station judging whether the signal level of output signals from each system is a threshold value and over, or not, said switch control station changing and controls a switch for a system which outputs signals whose signal level is threshold value and over.

7. A communication parts being provided with a system switching structure as claimed in claim 2, wherein said waiting system adjusts a signal level of output signals to be below threshold value, and said operating system adjusts a signal level of output signals to be threshold value and over.

8. A communication parts being provided with a system switching structure as claimed in claim 4, wherein said waiting system adjusts a signal level of output signals to be below threshold value, and said operating system adjusts a signal level of output signals to be threshold value and over.

9. A communication parts being provided with a system switching structure as claimed in claim 6, wherein said waiting system adjusts a signal level of output signals to be below threshold value, and said operating system adjusts a signal level of output signals to be threshold value and over.
